(19) United States
(12) Patent Application Publication
(10) Pub. No.: US 2014/0138049 A1
(43) Pub. Date: May 22, 2014

(54) VEHICLE WITH AIR CONDITIONER

(71) Applicants: Dirk Schroeder, Baar-Ebenhausen (DE); Hans Hammer, Pfaffenhofen (DE); Christian Rebinger, Ingolstadt (DE); Peter Heyl, Koeln (DE)

(72) Inventors: Dirk Schroeder, Baar-Ebenhausen (DE); Hans Hammer, Pfaffenhofen (DE); Christian Rebinger, Ingolstadt (DE); Peter Heyl, Koeln (DE)

(73) Assignee: VISTEON GLOBAL TECHNOLOGIES INC, Van Buren Township, MI (US)

(21) Appl. No.: 13/892,285

(22) Filed: May 12, 2013

Related U.S. Application Data
(63) Continuation of application No. PCT/EP2011/005484, filed on Oct. 29, 2011.

(30) Foreign Application Priority Data
Nov. 15, 2010 (DE) DE 102010051471.3

(51) Int. Cl. B60H 1/00

(52) U.S. Cl. CPC B60H 1/00321
USPC 165/63

(57) ABSTRACT

The invention relates to a vehicle with an air conditioner for heating inlet air flowing into a vehicle interior, the air conditioner including: a heater heat exchanger thermally coupled through a coolant cycle with a drive unit or similar; and a supplemental heat exchanger which is connected to a refrigerant cycle of the air conditioner and which transfers heat to the inlet air in heating mode, wherein the supplemental heat exchanger is configured with at least two rows including a first heat exchanger row and a second heat exchanger row in a refrigerant flow direction, wherein the first heat exchanger row and the second heat exchanger row are arranged in a refrigerant flow direction so that super cooling of a condensed refrigerant is provided in the second heat exchanger row and at least heat extraction of the refrigerant is provided in the first heat exchanger row.

### RELATED APPLICATIONS

This application is a continuation of PCT/EP2011/005484, filed on Oct. 29, 2011, claiming priority from German Patent Application DE 10 2010 051 471.3, filed on Nov. 15, 2010, both of which are incorporated in their entirety by this reference.

### FIELD OF THE INVENTION

The invention relates to a vehicle with an air conditioner according to the preamble of patent claim 1.

### BACKGROUND OF THE INVENTION

A vehicle interior is typically heated through a heater heat exchanger which is supplied with waste heat from a drive unit, for example an internal combustion engine, through a water based coolant cycle. Typically, a supplemental heater is associated with the heater heat exchanger. In vehicles with an air conditioner, the supplemental heater can be a condenser that is connected to the coolant cycle of the air conditioner, wherein the condenser transfers heat to air flowing into a vehicle interior during heating operations.

From DE 102 53 357 B4, a vehicle of this general type with an air conditioner is known. During heating operations, air flowing into the interior of the vehicle is heated through a heater heat exchanger, which is thermally coupled to the drive unit through a coolant cycle, and through a supplemental heat exchanger. The supplemental heat exchanger is connected to a refrigerant cycle of the air conditioner. The supplemental heat exchanger as well as the heater heat exchanger is arranged in an air conditioning device that is flowed through by air, wherein hot air flowing out of the air conditioning device is conducted to plural separate personal outlet vents.

Future diesel and gasoline engines will not be able to provide the required waste heat to heat a passenger compartment. Additional heating measures like fuel burners or PTC (positive temperature coefficient) heaters are required. A more efficient and environmentally sounder message is using the existing air conditioner and operating it in heat pump mode.

Besides switching valves, an additional condenser which is used as a supplemental heater and which is installed in the air conditioning device is being used.

### BRIEF SUMMARY OF THE INVENTION

It is an object of the invention to provide a vehicle with an air conditioner for cooling and heating with respective heating power and efficiency. Furthermore, the additional heat pump condenser shall be configured so that air exiting from it has good homogeneity, meaning an even temperature distribution which in turn positively influences control quality determining cabin comfort for the passengers.

The object is achieved through a vehicle with an air conditioner for heating inlet air flowing into a vehicle interior, the air conditioner including a heater heat exchanger thermally coupled through a coolant cycle with a drive unit or similar; and a supplemental heat exchanger which is connected to a refrigerant cycle of the air conditioner and which transfers heat to the inlet air in heating mode, wherein the supplemental heat exchanger is configured with at least two rows including a first heat exchanger row and a second heat exchanger row, wherein the first heat exchanger row and the second heat exchanger row are configured in air flow direction so that super cooling of the condensed refrigerant is provided in the first heat exchanger row and at least heat extraction and optionally condensation of the refrigerant is provided in the second heat exchanger row.

Preferred embodiments of the invention are disclosed in the dependent claims.

The condenser operating as a supplemental heater in heating operations is configured in at least two rows with a first heat exchanger row and with a second heat exchanger row connected therewith. The two heat exchanger rows and the heater heat exchanger connected to the coolant cycle are connected in series with one another in flow direction of the inflowing air, wherein depending on the application, initially the heater heat exchanger and then the supplemental heat exchanger or initially the supplemental heat exchanger and thereafter the heater heat exchanger is arranged. The double row configuration of the supplemental heat exchanger yields a flow pattern of the hot air flow exiting the air conditioning device which flow pattern has an even air temperature over the entire flow cross-section of the hot air flow. The main bleed air flow that is run through the double row supplemental heat exchanger can thus be divided into partial flows with respectively identical hot air temperature, wherein the hot air exiting at the different personal outlet valves reliably includes the hot air temperature set by the user.

Additionally, the two heat exchanger rows are adjusted to one another so that a super cooling of the condensing refrigerant is performed in the first heat exchanger row in air flow direction. Functionally separated therefrom, at least a heat extraction and optionally also a condensation of the refrigerant provided by the compressor is performed in the second heat exchanger row. Heat extraction means cooling the refrigerant until it reaches the dew line of a Mollier diagram. Separating heat extraction/condensation and super cooling facilitates efficient and even air heating. Through the separation of heat exchanger surfaces for super cooling and heat extraction/condensation, a high condensation temperature is reached compared to cooling operations. Thus, the heat transfer from the supplemental heat exchanger to the inflowing air can also be provided with an increased driving temperature difference. The heater arrangement including the supplemental heat exchanger and the heater heat exchanger can easily cover the heating requirement also in extreme situations.

As recited supra, the two row configuration of the supplemental heat exchanger according to the invention with a respective separation of the heat exchanger surfaces provides an increased condensation temperature in the heat pump process of the air conditioner. Thus, refrigerants can also be used in the refrigerant cycle, which only facilitate reaching reduced compressor outlet or condensation temperatures.

The two heat exchanger rows are flow-connected through a collector tube. The collector tube collects the liquid refrigerant exiting from the second heat exchanger row and transfers the liquid refrigerant to the first heat exchanger row. The collector tube can thus advantageously respectively open into a bottom side of the first and of the second heat exchanger row which easily facilitates collecting the condensing refrigerant in the collector tube. The collector tube can additionally include a separation cavity in which possibly refrigerant that is still in vapor state can be separated from the liquid refrigerant. This way a functional separation of the two heat exchanger rows between the heat extraction/condensation function and the super cooling function is obtained. The collector tube can be configured as a receiver. Furthermore, the collector can also be configured as a flat tube or as a double tube. Additionally, the collector tube can be positioned horizontally or vertically.

An increase of the condensation temperature of the refrigerant in the condensation row of the heat exchanger can be advantageously obtained by a reduction of the effective condensation surface. Such reduction of the condensation surface has the consequence during heat pump operations of the refrigerant cycle that a much higher condensation pressure with respectively increased condensation temperature is obtained in the condensation row of the supplemental heat exchanger.

Differently from the highly reduced heat extraction/condensation heat exchanger surface, the super cooling heat exchanger surface can be sized much larger. The heat exchanger surface for heat extraction depending on the refrigerant cycle with or without inner heat exchanger is almost negligible. The super cooling path can be much larger than the heat exchanger surface for condensation. The heat exchanger surface ratio between heat extraction/condensation and super cooling can thus vary between 70%/30% and 1%/99%. In this configuration it is important that the inner volumes especially of the super cooling section and of the subsequent conduits are minimized in order to be able to limit the filling volume to a particular amount. The described surface ratios relate to a front surface of a single row heater heat exchanger.

In a multi-row configuration, introducing a standardized volume ratio is useful, since the surfaces are identical in several levels. When introducing a standardized volume ratio for multi-row heat exchangers with identical surface ratios of the heat exchanger planes (otherwise computational adaptation), the following configuration can be obtained: 15% super cooling/85% condensation, up to 99% super cooling/1% condensation.

Differently from the sizing of the heat exchanger rows according to the invention, the conventional condensers of an air conditioner are designed the other way around with a rather large heat extraction/condensation path and a respectively reduced super cooling path above the recited surface ratio of 70%/30%.

For effective heat transfer from the supplemental heat exchanger to the inflowing air, it is preferred when the super cooling row is arranged first in flow direction of the inflowing air and the heat extraction/condensation row of the supplemental heat exchanger is arranged downstream therefrom. This way, the inflowing air that needs to be heated can be initially preheated in the super cooling row in counter flow and can subsequently be brought to the exit temperature in the heat extraction/condensation row.

The supplemental heat exchanger and the heater heat exchanger form a heating arrangement of the air conditioning device of the air conditioner. The air conditioning device can also include an evaporator which can cool the inflowing air during cooling operations or for air dehumidification. Depending on the heating power to be achieved, the arrangement in flow direction can be as follows: initially there is the evaporator and subsequently the supplemental heat exchanger and then the heater heat exchanger and thereafter optionally a PTC heating element. Alternatively thereto, the heater heat exchanger can be arranged directly downstream from the evaporator. The sequence depends on the application.

Depending on the configuration, the two supplemental heat exchanger rows with the refrigerant inlet/outlet can be configured single path or multi-path. Additionally the supplemental heat exchanger can also be configured in three rows with a special heat extraction row and a condensation row and a super cooling row.

### BRIEF DESCRIPTION OF THE DRAWINGS

An embodiment of the invention is subsequently described with reference to drawing figures, wherein:

FIG. 1 illustrates a diagram of an air conditioner of a motor vehicle in heating mode;

FIG. 2 illustrates a diagram according to FIG. 1 with the air conditioner in cooling mode; and

FIG. 3 illustrates a heat pump process in heating mode of the air conditioner in a Mollier diagram.

### DETAILED DESCRIPTION OF THE INVENTION

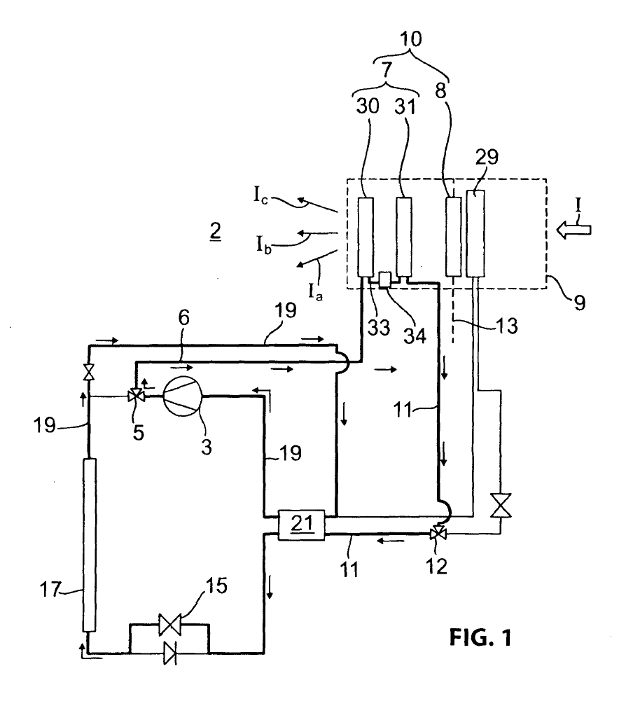

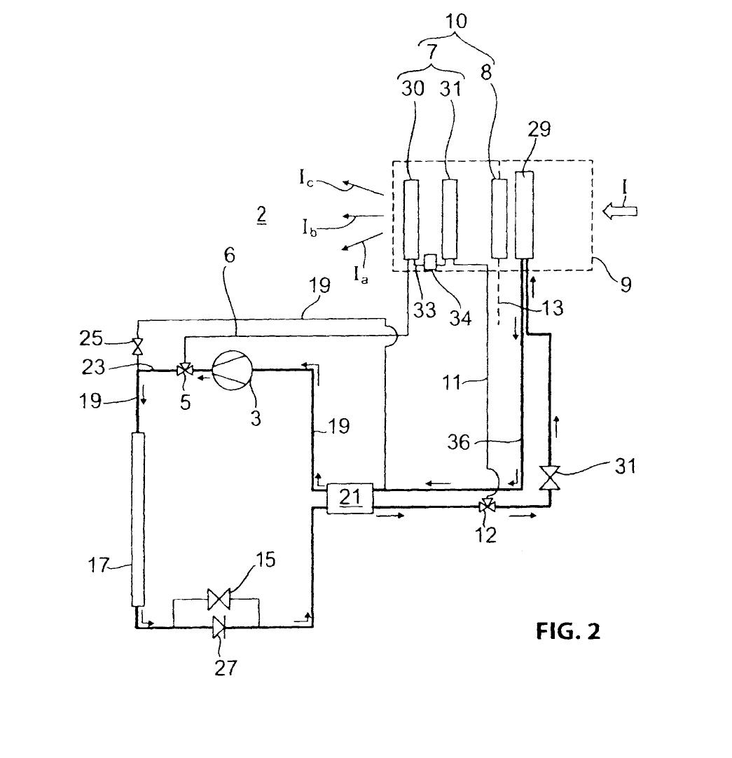

FIGS. 1 and 2 illustrate an air conditioner of a motor vehicle for cooling or heating a vehicle interior 2. FIG. 1 illustrates the heating mode for heating the vehicle interior 2, wherein the components flowed through with refrigerant are emphasized through thick lines over the components that are shut down in heating mode. Consequently, the refrigerant is run by a compressor 3 preferably through a 3/2 way valve into a first high pressure conduit 6 which leads to a supplemental heat exchanger 7 in arrow direction. The supplemental heat exchanger 7 is arranged in an air conditioning device drawn in dashed lines within an air channel of the air conditioning device 9, wherein incoming air I is run through the air channel into the vehicle interior 2. After heat up in the air conditioning device 9, hot air is run for example in three separate hot air streams Iₐ, I_{b}, I_{c} to various personal outlet valves, for example defrost valves, body valves and foot area valves.

The heat exchanger 7 which has at least two rows according to the invention forms a heater arrangement 10 together with a heater heat exchanger 8, wherein the heater arrangement is flowed through by the inlet air I. The heater heat exchanger 8 is arranged in a schematically drawn coolant cycle 13 through which waste heat generated in the non-illustrated internal combustion engine can be run to the heater heat exchanger 8.

According to FIG. 1, the two row supplemental heat exchanger 7 operating as a condenser is flow coupled through a second high pressure conduit 11 and through a 3/2 way valve 12 with a radiator heat exchanger 7 with an expansion device 15 connected there between. This radiator side heat exchanger 17 operates as an evaporator in the heating mode, wherein the evaporator extracts heat from the ambient air. In cooling mode, the radiator heat exchanger operates as a condenser. The radiator side heat exchanger 17 is run downstream with a low pressure conduit 7 to the suction side of the compressor 3. The low pressure conduit 19 is thus run through an interior heat exchanger 21 in which a heat exchange with the high pressure side, this means from the high pressure conduit 11, can be performed. A direct connection of the conduit 19 in front of the compressor 3 is also feasible.

As apparent from FIG. 1, the supplemental heat exchanger 7 includes a first heat exchanger row 31 and a second heat exchanger row 30. These are connected in series with one another and flow connected with one another through a collector tube 33 with a precipitation reservoir 34. The collector tube 33 in this embodiment leads into the first and the second heat exchanger rows 30, 31 respectively on a bottom side.

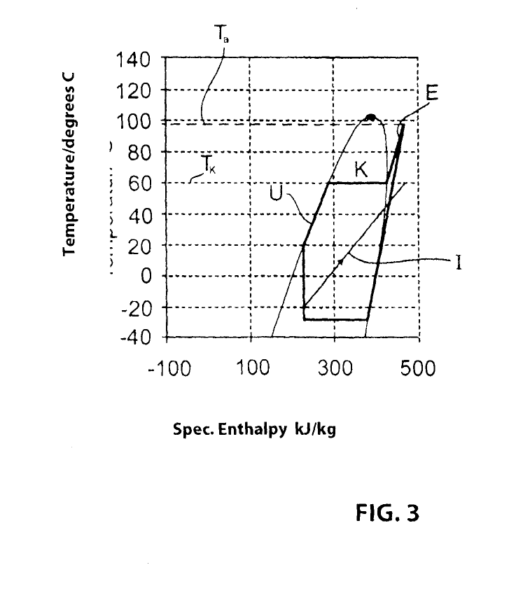

The two heat exchanger rows 30, 31 are configured according to the invention so that a heat extraction E and a condensation K of the refrigerant can be provided in the second supplemental heat exchanger 30 looking downstream. In the first heat exchanger row 31 on the other hand side super cooling U of the condensed refrigerant is performed. For illustration purposes, FIG. 3 illustrates a heat pump process in a Mollier diagram in which the process steps heat extraction condensation and super cooling are respectively designated with E, K, and U. The illustrated diagram relates to the exemplary refrigerant R134a. From this it is apparent that a compressor outlet temperature Tₐ of the refrigerant is at approximately 95° C. while the condensation K of the second heat exchanger row 30 occurs at a condensation temperature T_{K} of 60° C.

According to the invention, the super cooling row 31 of the supplemental heat exchanger 7 is arranged in front of the heat extraction/condensation row 30 in flow direction of the inlet air I. Thus, the inlet air I flowing into the air conditioning device 9 is preheated in counter flow by the super cooling row 31 and subsequently heated to the air conditioning device outlet temperature through the condensation/heat extraction row 30. In order to achieve a condensation temperature T_{K}, the heat extraction I condensation row 30 is configured with a highly reduced refrigerant-air-heat exchanger surface. The refrigerant entering the second heat exchanger row 30 in a gaseous manner is liquefied at a high condensation pressure which facilitates an accordingly high condensation temperature T_{K}. Proportional to the increase in condensation temperature T_{K} thus achieved, a rather high driving temperature difference between the heat exchanger row 30 and the inlet air I passing through is achieved.

The collector tube 33 facilitates a functional separation between the heat extraction/condensation in the heat exchanger row 30 and the super cooling in the heat exchanger row 31. The condensing refrigerant exiting from the second row 30 accumulates in the collector tube 33, wherein the refrigerant that is still gaseous can be separated. Thus, only liquid refrigerant is introduced into the super cooling row 31.

FIG. 2 illustrates the cooling mode of the air conditioner, wherein the conduits that are flowed through by the refrigerant are emphasized in thick lines. In cooling mode the 3/2 way valve 5 blocks the conduit 6 downstream of the compressor 3 to the supplemental heat exchanger 7 in the air conditioning device 9, wherein an intermediary conduit 23 towards the conduit 19 is opened. At the branch off to the conduit 19, the shutoff valve 25 is closed on the side oriented away from the heat exchanger 17. The refrigerant is thus run through the heat exchanger 17 on the radiator side, wherein the heat exchanger 17 operates as a condenser in cooling mode and passes heat to the ambient air.

Subsequently the refrigerant is run through a one way valve 27 connected in parallel to the expansion device 15 through the interior heat exchanger 21 and through the 3/2 way valve 12 to an evaporator 29 within the air conditioning device 9. An expansion device 31 is connected in front of the evaporator 29. The refrigerant exiting from the evaporator 29 is run back to the compressor 3 through the conduit 36, the interior heat exchanger 21 and the conduit 19.

As a matter of principle, this idea can also be used for establishing a radiator side heat exchanger, the condenser of the air conditioner.

The function of the heater heat exchanger 8 is significantly influenced by the operation of the heat pump. Air can be heated exclusively by the heat pump or by the heat pump and the motor cooling cycle of which FIG. 1 only illustrates the refrigerant conduit 13. Accordingly, the operating mode of the supplemental heat exchanger is different. Depending on the operating mode, the power but also the efficiency of the total system is being influenced.

What is claimed is:

1. A vehicle with an air conditioner for heating inlet air flowing into a vehicle interior, the air conditioner comprising:
a heater heat exchanger thermally coupled through a coolant cycle with a drive unit or similar; and
a supplemental heat exchanger which is connected to a refrigerant cycle of the air conditioner and which transfers heat to the inlet air in heating mode,
wherein the supplemental heat exchanger is configured with at least two rows including a first heat exchanger row and a second heat exchanger row in a refrigerant flow direction,
wherein the first heat exchanger row and the second heat exchanger row are arranged in the refrigerant flow direction so that super cooling of a condensed refrigerant is provided in the second heat exchanger row and at least heat extraction of the refrigerant is provided in the first heat exchanger row.

2. The vehicle according to claim 1, wherein the first heat exchanger row and the second heat exchanger row are connected with a collector tube which collects liquid refrigerant exiting from the first heat exchanger row and transfers it to the second heat exchanger row.

3. The vehicle according to claim 2, wherein the collector tube leads into the first heat exchanger row and the second heat exchanger row on a bottom side.

4. The vehicle according to claim 1, wherein the second heat exchanger row for super cooling is arranged first in a flow direction of the inlet air and the first heat exchanger row for heat extraction including condensation of the supplemental heat exchanger is arranged thereafter in the flow direction of the inlet air.

5. The vehicle according to claim 1, wherein the second heat exchanger row for super cooling is sized larger than the first heat exchanger row for heat extraction including condensation.

6. The vehicle according to claim 1,
wherein a heat exchanger surface of the second heat exchanger row for super cooling is many times larger than a heat exchanger surface of the first heat exchanger row for heat extraction including condensation,
wherein a heat exchanger surface ratio between heat extraction including condensation and super cooling varies between 70%/30% and 1%/99%,
wherein a ratio between 15% super cooling/85% condensation and 99% super cooling/1% condensation is provided in particular for a standardized volume ratio for a multi row arrangement.

7. The vehicle according to claim 1, wherein an air conditioning device of the vehicle includes an evaporator connected in the refrigerant cycle in addition to a heater arrangement including the supplemental heat exchanger and the heater heat exchanger.

8. The vehicle according to claim 1, wherein the supplemental heat exchanger is configured with three rows including a heat extraction row, a condensation row, and a super cooling row.

9. The vehicle according to claim 1, wherein each row of the supplemental heat exchanger is configured with a single path or a multi path refrigerant inlet and outlet.

10. A heat pump arrangement or supplemental heat exchanger in a vehicle according to claim 1 in combination with connecting an engine cooling cycle.

11. A vehicle with an air conditioner for heating inlet air flowing into a vehicle interior, the air conditioner comprising:
a heater heat exchanger thermally coupled through a coolant cycle with a drive unit or similar; and
a supplemental heat exchanger which is connected to a refrigerant cycle of the air conditioner and which transfers heat to the inlet air in heating mode,
wherein the supplemental heat exchanger is configured with at least two rows including a first heat exchanger row and a second heat exchanger row,
wherein the first heat exchanger row and the second heat exchanger row are configured in refrigerant flow direction so that super cooling of a condensed refrigerant is provided in the second heat exchanger row and heat extraction including condensation of the refrigerant is provided in the first heat exchanger row.
